(19) United States
(12) Patent Application Publication
(10) Pub. No.: US 2004/0028895 A1
(43) Pub. Date: Feb. 12, 2004

(54) Adhesive tape for liquid crystal display module combining light reflectivity and light shielding

(75) Inventors: Akira Yamakami, Ageo-shi (JP); Kosuke Tanabe, Saitama-shi (JP); Ryuichi Nakamura, Ageo-shi (JP); Akihiro Kuwashita, Toda-shi (JP); Akihiro Yamada, Saitama-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Dainippon Ink and Chemicals, Inc., Tokyo (JP)

(21) Appl. No.: 10/636,631

(22) Filed: Aug. 8, 2003

(30) Foreign Application Priority Data
Aug. 12, 2002 (JP) P2002-234438

(51) Int. Cl. B32B 7/12

(52) U.S. Cl. 428/354

(57) ABSTRACT

An adhesive tape (a) which combines light reflectivity and light shielding characteristics, which is used for bonding between an LCD panel and a backlight case of an LCD module; (b) and which comprises a backing formed by laminating a light reflective layer and a light shielding layer, and an adhesive layer provided on at least one surface of the backing; (c) wherein the light reflective layer is formed of a white resin film with a thickness within a range from 10 to 30 μm, and a tensile strength of at least 10.0 N/10 mm.

### BACKGROUND OF THE INVENTION

1. Field of the Invention

The present invention relates to an adhesive tape with good light reflectivity and light shielding characteristics, which is used for bonding between a liquid crystal display (LCD) panel and a backlight case.

2. Description of the Related Art

Liquid crystal display (LCD) modules are used in a wide range of fields including word processors and personal computers, and have become particularly prevalent as the display devices within compact electronic devices such as PDAs, mobile telephones and PHS. In these types of LCD modules, LCD modules with a sidelight type backlight system (a schematic illustration is shown in FIG. 8) typically comprise a backlight case 16, with a reflector 15, a light guide plate 14, a diffusion sheet 12, where necessary a prism sheet 11 (to increase brightness), and an LCD panel 17 layered sequentially inside the backlight case 16. A light source 13 such as an LED (light emitting diode) or a cold cathode tube with a lamp reflector is provided to the side of the light guide plate 14.

In addition, an adhesive tape 10 (that is usually punched out in the shape of the casing, and typically has a width within a range from approximately 0.5 mm to 10 mm) is sandwiched between the LCD panel 17 and the backlight case 16. The adhesive tape 10 contacts not only the case 16, but also the prism sheet 11, and performs the functions of securing the diffusion sheet 12 and the other components positioned beneath the prism sheet 11, as well as preventing the entry of dirt into the module, and providing a degree of cushioning, thereby prevent breakage of any of the aforementioned components.

As described above, current trends within the field of LCD modules include a move towards lighter and thinner modules, as well as a move towards larger screens to cope with the demands of displaying increasing quantities of information. As a result of these trends, the positions of the light source 13 and the LCD panel 17 have moved closer together, which has generated a problem in that light from the light source can leak through the adhesive tape 10, causing a deterioration in the outward appearance of the display.

Consequently, the adhesive tape 10 sandwiched between the LCD panel 17 and the backlight case 16 requires good light shielding characteristics, and must be able to improve the appearance of the display surface of the LCD panel, while blocking light from Penetrating into the driver 9 used to drive the LCD panel 17 and preventing malfunctions.

In recent years, in addition to the above requirement of shielding light, the adhesive tape 10 should now also have a high level of reflective performance to reflect light that penetrates into the areas surrounding the backlight case 16, and guide the light from the light source 13 to the rear surface of the LCD panel 17 with a high degree of efficiency. This type of adhesive tape 10 is more compatible with the thin displays required for portable devices, and also enables a reduction in power consumption. Hence, an adhesive tape 10 that is thin and yet offers good light reflectivity and light shielding characteristics has been keenly sought.

The process for attaching an LCD panel 17 to a backlight case 16 using an adhesive tape with good reflectivity and light shielding characteristics, for example in the case in which the adhesive tape 10 is a double sided tape with an adhesive layer on both sides, typically involves bonding the double sided adhesive tape 10 to the backlight case 16 (including the prism sheet 11), and then securing the LCD panel 17 by placement on top of the adhesive tape 10. In this securing process, the LCD panel 17 may not be secured in the correct position at the first attempt, and may need to be removed and reattached. In such a case, the misaligned LCD panel 17 must be separated from the backlight case 16, and the adhesive tape 10 must separate from the LCD panel 17 without tearing or undergoing any internal rupture or the like, while remaining firmly bonded to the top of the backlight case 16 (hereafter this property is described as reworkability).

If the adhesive tape 10 is a single sided adhesive tape, then the LCD panel 17 is secured to the backlight case 16 by either bonding the adhesive tape 10 to the backlight case 16 (including the prism sheet 11) and placing the LCD panel 17 on top of the adhesive tape, or placing the LCD panel 17 with the adhesive tape 10 bonded thereto on top of the backlight case 16, and then securing the configuration with a clamp type component that prevents the LCD panel 17 from separating from the backlight case 16. In this case, as with the case of the double sided adhesive tape described above, if the LCD module needs to be dismantled, then the adhesive tape 10 must be removed from the LCD panel 17 or the backlight case 16, and consequently, once again, the tape requires good reworkability to prevent tearing or internal rupture during the removal of the adhesive tape.

A white film for the reflecting plate of a surface light source that utilizes a white film substrate with a thickness of 50 to 250 μm and good light reflectivity is disclosed in Japanese Unexamined Patent Application, First Publication No. 2002-50222 A. Using a white film substrate of good reflectivity as disclosed in this patent application, an adhesive tape with light reflectivity and light shielding characteristics can be produced with relative ease. However recently, adhesive tapes used for the purposes described above require a substrate film that offers good reflectivity and light shielding characteristics and also has minimal thickness, and if a white film substrate as disclosed in the published patent application described above is used to produce an adhesive tape by providing an adhesive layer on either one side or both sides of the substrate, the overall thickness of the adhesive tape is too large.

Moreover, if a white film substrate disclosed in the above patent application is reduced in thickness and then used to produce an adhesive tape, the adhesive tape is unable to satisfy the types of characteristics required for an adhesive tape used in the production of an LCD module.

### BRIEF SUMMARY OF THE INVENTION

An object of the present invention is to provide an adhesive tape used for bonding between an LCD panel and a backlight case, which is thin, displays excellent reworkability, and combines good light reflectivity and light shielding characteristics.

Furthermore, another object of the present invention is to provide an adhesive tape as described above, which resolves the problems above and displays excellent light reflectivity and light shielding characteristics.

As a result of intensive research, the inventors of the present invention discovered that an adhesive tape (a) which combines light reflectivity and light shielding characteristics, which is used for bonding between the LCD panel and the backlight case of an LCD module, (b) and which comprises a backing formed by laminating a light reflective layer and a light shielding layer, and an adhesive layer provided on at least one surface of the backing, (c) wherein the light reflective layer is formed of a white resin film with a thickness within a range from 10 to 30 μm, and a tensile strength of at least 10.0 N/10 mm was able to achieve the object of the present invention, and were hence able to complete the invention.

The adhesive tape of the present invention, which combines light reflectivity and light shielding characteristics, uses a light reflective layer that displays adequate tensile strength even for very thin layers, and consequently the overall thickness of the adhesive tape can be reduced and an adhesive tape with excellent reworkability can be provided.

An adhesive tape of the present invention has minimal thickness while offering excellent reworkability, and is consequently ideal as an adhesive tape for securing the LCD panel in LCD modules in which the positions of the light source and the LCD panel have moved closer together in order to meet the demands for lighter and thinner modules, and for larger screens to display the increasing quantities of information. Furthermore, because an adhesive tape of the present invention displays good light reflectivity and light shielding characteristics, the light from the backlight can be used efficiently, enabling the appearance of the LCD panel to be improved and the penetration of light into the driver to be blocked, thereby significantly reducing malfunctions.

### BRIEF DESCRIPTION OF THE DRAWINGS

FIG. 1 is a schematic cross-sectional view showing an example of an adhesive tape of the present invention, comprising a backing 3, formed by laminating a light reflective layer 1 formed from a white resin film 5 and a light shielding layer 2, and an adhesive layer 4 provided on the backing 3 on the side of the light shielding layer 2.

FIG. 2 is a schematic cross-sectional view showing another example of an adhesive tape of the present invention, comprising a backing 3, formed by laminating a light reflective layer 1 formed from a white resin film 5 and a light shielding layer 2, and an adhesive layer 4 provided on the backing 3 on the side of the light reflective layer 1.

FIG. 3 is a schematic cross-sectional view showing yet another example of an adhesive tape of the present invention, comprising a backing 3, formed by laminating a light reflective layer 1 formed from a white resin film 5 and a light shielding layer 2, and adhesive layers 4 provided on both sides of the backing 3.

FIG. 4 is a schematic cross-sectional view showing yet another example of an adhesive tape of the present invention, which uses a white resin film 5 with white ink layers 6 provided on both sides thereof as a light reflective layer 1, and comprises a backing 3, formed by laminating the light reflective layer 1 and a light shielding layer 2, and adhesive layers 4 provided on both sides of the backing 3.

FIG. 5 is a schematic cross-sectional view showing yet another example of an adhesive tape of the present invention, comprising a backing 3, formed by laminating a light reflective layer 1 formed from a white resin film 5 and a light shielding layer 2 formed from a black ink layer 8 and a thin metal layer 7, and an adhesive layer 4 provided on the backing 3 on the side of the light shielding layer 2.

FIG. 6 is a schematic cross-sectional view showing yet another example of an adhesive tape of the present invention, comprising a backing 3, formed by laminating a light reflective layer 1 formed from a white resin film 5 and a light shielding layer 2 formed from a black ink layer 8 and a thin metal layer 7, and adhesive layers 4 provided on both sides of the backing 3.

FIG. 7 is a schematic cross-sectional view showing yet another example of an adhesive tape of the present invention, comprising a backing 3, formed by laminating a light reflective layer 1 formed from a white resin film 5 and a light shielding layer 2 formed from a thin metal layer 7, and adhesive layers 4 provided on both sides of the hacking 3.

FIG. 8 is a schematic cross-sectional view showing an LCD module in which a component such as an LCD panel 17 is secured to a backlight case 16 using an adhesive tape 10.

### DETAILED DESCRIPTION OF THE INVENTION

As follows is a more detailed description of an adhesive tape combining light reflectivity and light shielding characteristics according to the present invention, focusing on the structural elements of the adhesive tape.

(Usage within LCD Modules)

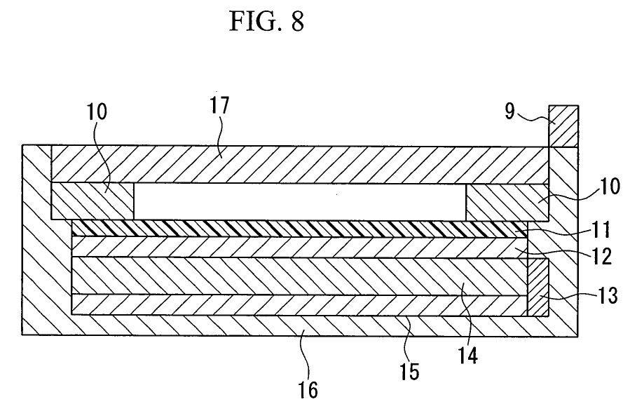

An adhesive tape combining light reflectivity and light shielding characteristics according to the present invention (hereafter referred to as an “adhesive tape of the present invention”) is bonded in a position shown by an adhesive tape 10 in FIG. 8. In this bonding process, the adhesive tape is oriented so as to contact a backlight case 16 and a prism sheet 11, with a light shielding layer 2 of the adhesive tape facing an LCD panel 17, and a light reflective layer 1 facing a light source 13. If the adhesive tape of the present invention is a double sided adhesive tape, the adhesive tape is bonded to both the LCD panel 17 and the backlight case 16 (the example in FIG. 8 uses a prism sheet 11, and in such a case, the adhesive tape of the present invention is also bonded to the surface of the prism sheet 11). Alternatively, if the adhesive tape is a single sided adhesive tape, the adhesive tape is bonded to either one of the LCD panel 17 and the backlight case 16. In the case of a single sided adhesive tape, the LCD panel 17 is secured to the backlight case 16 using a clamp type component. Because an adhesive tape of the present invention displays excellent light reflectivity and light shielding characteristics, light from a light source 13 can be reflected efficiently onto the LCD panel 17, while light can also be prevented from penetrating into a driver 9.

(Structure of Adhesive Tapes of the Present Invention)

As follows is a description of embodiments of adhesive tapes of the present invention with reference to the appended drawings.

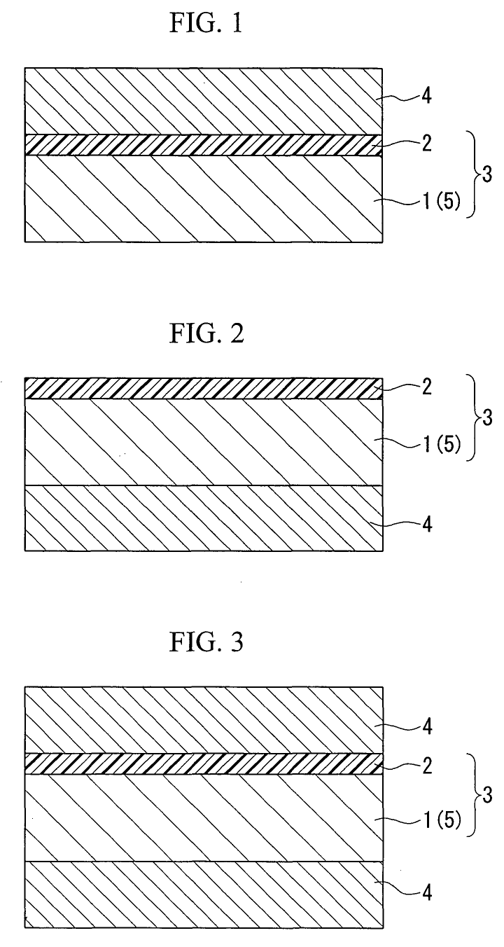

FIG. 1 shows an embodiment comprising a backing 3, formed by laminating a light reflective layer 1 and a light shielding layer 2, and an adhesive layer 4 laminated to the backing 3 on the side of the light shielding layer 2. FIG. 2 shows an embodiment comprising a backing 3, formed by laminating a light reflective layer 1 and a light shielding layer 2, and an adhesive layer 4 laminated to the backing 3 on the side of the light reflective layer 1. Furthermore, FIG. 3 shows an embodiment comprising a backing 3, formed by laminating a light reflective layer 1 and a light shielding layer 2, and adhesive layers 4 laminated to both sides of the backing 3. An adhesive tape of the present invention can be either a single sided tape such as those in FIG. 1 and FIG. 2, or a double sided adhesive tape such as that of FIG. 3. Furthermore, the adhesive layer 4 may be a single layer of adhesive, although multi-layered materials formed from a plurality of adhesive layers, such as in a double sided adhesive tape, are also suitable.

The light shielding layer 2 can be formed from a layer of black ink, for example. Furthermore, the adhesive layer provided on the side of the light shielding layer 2 in the embodiments of FIG. 1 and FIG. 3 may be a black colored adhesive layer. In addition, the light shielding layer 2 in FIG. 2 may be a layer formed from a black colored adhesive. Ink layers and adhesive layers can be blackened by adding known pigments or dyes. Carbon black is particularly preferred.

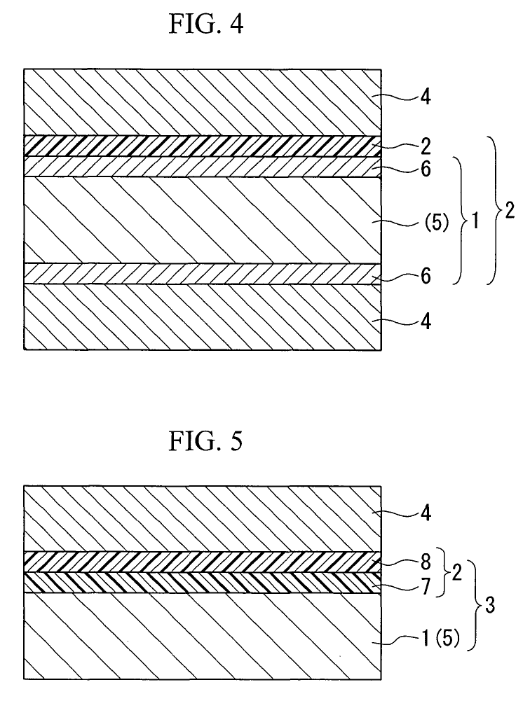

The light reflective layer 1 is formed from a white resin film 5 as described below. A white ink layer 6 can also be provided on at least one surface of the white resin film 5. If such an ink layer is used, the white ink layer should preferably contain a higher white colorant content than the white resin film 5. By so doing, the visible light reflectance of the adhesive tape can be improved. FIG. 4 shows an embodiment using a laminated film in which a white resin film 5 with white ink layers 6 provided on both sides thereof is used as the light reflective layer 1.

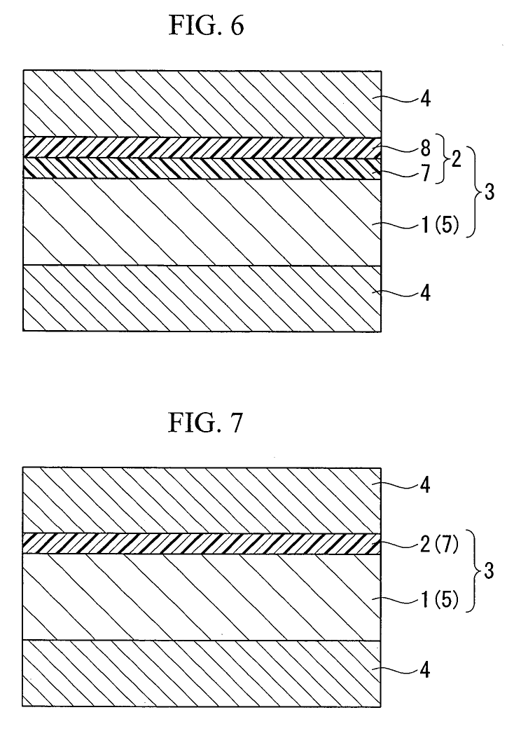

FIG. 5 through FIG. 7 show embodiments that use a light shielding layer 2 comprising a thin metal layer 7. The thin metal layer 7 reflects light that is not completely reflected by the light reflective layer 1 and passes through the layer back towards the light source 13. This results in a further improvement in the light reflectivity and light shielding characteristics of an adhesive tape of the present invention. FIG. 7 represents an example that uses a lone thin metal layer 7, whereas FIG. 5 and FIG. 6 show examples in which a black ink layer 8 is provided on top of the thin metal layer 7. For an adhesive tape of the present invention, the embodiments of FIG. 5 and FIG. 6 are preferred to the embodiment shown in FIG. 7. If the embodiment of FIG. 7 is used, then the adhesive layer 4 laminated onto the thin metal layer 7 should preferably be a black colored adhesive layer.

An adhesive tape of the present invention is preferably an adhesive tape combining light reflectivity and light shielding characteristics, in which adhesive layers 4 are laminated to both sides of a backing 3 formed by laminating a light reflective layer 1 and a light shielding layer 2, as shown in FIG. 3, FIG. 4, FIG. 6 and FIG. 7. By using this type of double sided adhesive tape, the LCD panel 17 can be secured to the backlight case 16 without having to use a component to prevent the LCD panel 17 from separating from the backlight case 16.

The light reflectance at the opposite side of the adhesive tape to the light shielding layer 2, that is, on the side of light reflective layer 1, is preferably at least 60%. The light reflectance at the light reflective layer 1 of the adhesive tape can either be measured as the light reflectance of the light reflective layer 1 itself (as in the case of the embodiment 1), or can be measured with an adhesive layer provided on top of the light reflective layer 1 (as in the case of the embodiment shown in FIG. 2). In the case of the embodiment shown in FIG. 2, the value of the light reflectance does not represent the light reflectance of the light reflective layer 1, but rather represents the light reflectance of the adhesive tape including the adhesive layer. Adhesive tapes for which the visible light reflectance value is at least 65% are preferred, and values of 70% or more are even more preferred. Visible light reflectance values of at least 60% are preferred as they enable the brightness of the LCD panel to be improved.

Light reflectance is measured with a spectrophotometric type calorimeter SE-2000 (manufactured by Nippon Denshoku Industries Co., Ltd.), in accordance with JIS Z-8722, by measuring the spectral reflectance at 10 nm intervals across the wavelength range from 400 to 700 nm, and then calculating the average of these measured values (the average light reflectance).

In addition, the light transmittance of an adhesive tape of the present invention is preferably no more than 1%. If the light transmittance is no more than 1% then light leakage is less likely to occur, and the appearance of the LCD panel improves.

Light transmittance is measured with a spectrophotometer V-520-SR (manufactured by Jasco Corporation), in accordance with JIS Z-8722, by measuring the spectral transmittance at 10 nm intervals across the wavelength range from 400 to 700 nm, and then calculating the average of these measured values (the average light transmittance). Furthermore, in order to block the penetration of light into the driver that drives the LCD panel and prevent malfunctions, the light transmittance across a range from 200 to 1100 nm is preferably no more than 0.1%, and most preferably less than 0.01%.

<The Light Reflective Layer 1>

(Thickness of the White Resin Film 5)

In an adhesive tape of the present invention, the thickness of the white resin film 5 of the light reflective layer 1 is preferably within a range from 10 to 30 μm, and even more preferably from 12 to 25 μm. If the thickness is less than 10 μm, the workability and light reflectivity of the tape deteriorate markedly. In contrast if the thickness exceeds 30 μm then the tape becomes overly thick, which is unsuitable for producing thin LCD modules.

(Production of the White Resin Film 5)

The white resin film 5 may be either a kneaded film produced by finely dispersing a white colorant in a resin and then passing the mixture through a molten extrusion process to form a film, or a coated film in which a white colored ink containing a white colorant is applied to either one side or both sides of a resin film.

A preferred white resin film 5 for use in the present invention is produced by kneading together a resin and a white colorant, subsequently passing the mixture through a molten extrusion process to form an unstretched film, and then subjecting the film to biaxial stretching.

(White Colorant)

Suitable examples of the white colorant used in the white resin film 5 include barium sulfate, titanium dioxide, calcium carbonate, silica, talc and clay. These colorants may be used singularly or in combinations of two or more materials. In terms of the light reflectance efficiency for light of wavelength less than 390 nm, titanium dioxide and barium sulfate are preferred, and of these two, titanium dioxide is particularly preferred.

The average particle size of the titanium dioxide is preferably within a range from 0.1 to 0.4 μm. If the particle size is less than 0.1 μm then yellowing of the reflected light increases, whereas particle sizes exceeding 0.4 μm increase blueing.

The quantity of titanium dioxide added is preferably within a range from 10 to 40% by weight, and even more preferably from 15 to 35% by weight based on the white resin film. At quantities less than 10% by weight, the average light reflectance falls, whereas if the quantity exceeds 40% by weight, the orientation of the film deteriorates, causing a marked deterioration in productivity and workability. Provided the quantity of the white colorant is kept within the above range, a light reflective layer 1 with a light reflectance that falls within the aforementioned range can be formed.

The light reflective layer 1 in an adhesive tape of the present invention preferably uses a white resin film 5 containing fine particles of a white colorant, as described above. By using this type of resin film, a light reflective layer 1 with good light scattering characteristics can be formed. As a result, isolated areas of strong reflected light do not occur, the light from the light source is reflected over a wide range, and light of uniform intensity can be projected onto the LCD panel.

(Resin Composition of the Film)

Suitable examples of the resin for the white resin film 5 include cellophane, cellulose acetate, polyvinyl chloride, polyethylene, polypropylene, polyester, polyethylene tetrafluoride, polyvinyl fluoride, polyimide, polycarbonate and polystyrene. Of these, polyester is preferred as it offers superior heat resistance and light resistance. Typically known additives such as antioxidants and antistatic agents may also be added to the polyester.

Polyester is a polymer obtained through a condensation polymerization of a diol and a dicarboxylic acid. Examples of the dicarboxylic acid include terephthalic acid, isophthalic acid, 2,6-naphthalenedicarboxylic acid, 4,4′-diphenyldicarboxylic acid, adipic acid and sebacic acid, whereas examples of the diol include ethylene glycol, 1,4-butanediol, 1,4-cyclohexanedimethanol, 1,6-hexanediol, diethylene glycol, neopentyl glycol and polyoxyalkylene glycol.

In terms of heat resistance, strength and cost, polyethylene terephthalate (PET) produced using terephthalic acid and ethylene glycol as raw materials is the most preferred resin for use in a white resin film 5 of the present invention.

(Viscoelasticity of the White Resin film 5)

Measurement of the viscoelasticity of a white resin film 5 used in an adhesive tape of the present invention, under conditions including 0.1 Hz expansion in the longitudinal direction, should preferably reveal a maximum value for the loss tangent that falls within a range from 60 to 100° C. Resin films in which this maximum value occurs between 70 and 95° C. are even more preferred. If the maximum value for the loss tangent occurs at a temperature less than 60° C. then the heat resistance deteriorates, whereas if the maximum value occurs at a temperature exceeding 100° C., then addition of a high concentration of pigment becomes difficult. Furthermore, from the viewpoint of ensuring a good level of reworkability, the storage elastic modulus of the resin film at 23° C. is preferably within a range from 2.5×10⁹ to 4.0×10⁹ Pa, and even more preferably from 3.0×10⁹ to 3.5×10⁹ Pa.

The tensile strength of a white resin film 5 used in an adhesive tape of the present invention is preferably at least 10.0 N/10 mm, and even more preferably at least 15.0 N/10 mm, and most preferably more than 20.0 N/10 mm. If the tensile strength of the white resin film 5 is less than 10.0 N/10 mm, the tape is prone to tearing during rework. Generally larger tensile strength values are preferred, although from a practical viewpoint, the production of resin films with tensile strength exceeding 75.0 N/10 mm is problematic. Hence, the upper limit for the tensile strength of an adhesive tape of the present invention is 75.0 N/10 mm.

Provided the tensile strength of the white resin film 5 falls within the above range, an adhesive tape of the present invention will remain bonded to the backlight case and not tear or rupture, even if the LCD panel needs to be removed from the backlight case to realign the position of the LCD panel. As described above, a white resin film 5 used in an adhesive tape of the present invention is thin and comprises a high concentration of a white colorant, but by also ensuring that the tensile strength of the film falls within the above range, an adhesive tape with excellent reworkability can be produced. An example of a commercially available film that satisfies the above physical requirements and is ideally suited to use as the white resin film 5 of the present invention is TEFLEX FW2#13 (a polyethylene terephthalate (PET) film) manufactured by Teijin DuPont Films Ltd.

(The White Ink Layer 6)

In order to further improve the light reflectance, a white ink layer 6 is preferably provided on at least one surface, and even more preferably on both surfaces, of the white resin film 5 used to form the light reflective layer 1 in an adhesive tape of the present invention. The thickness of this white ink layer 6 is preferably from 0.5 to 5 μm. Furthermore, the white ink layer 6 may be formed as a single layer, but is preferably formed by laminating from 2 to 4 layers.

The pigment used in the white ink can utilize the same materials used in the resin film. Titanium dioxide and barium sulfate are preferred, and of these two, titanium dioxide is particularly preferred from the viewpoint of light reflectivity.

The average particle size of the white ink pigment is preferably within a range from 0.1 to 0.4 μm. The quantity of the pigment is preferably from 40 to 70% by weight, and even more preferably from 55 to 65% by weight of the ink. At quantities less than 40% by weight the improvement in reflectance is limited, whereas if the quantity exceeds 70% by weight then the ease of application of the ink deteriorates.

Inks containing a resin component with a hydroxyl value of 1 to 10 and an isocyanate based cross linking agent are preferred, as they generate good adhesion between the white resin film 5 and the ink, and also between the ink and the adhesive layer 4. Inks in which the resin component is a mixture of a urethane resin and a vinyl chloride-vinyl acetate-vinyl alcohol terpolymer are particularly preferred.

<The Light Shielding Layer 2>

The light shielding layer 2 may be a dark color other than black, such as purple or dark blue, provided the layer still performs the function of shielding the light from the light source 13 of the LCD module. The light shielding layer 2 may also adopt any of a variety of structures. As follows is a description of examples of preferred forms of the light shielding layer 2 within an adhesive tape of the present invention.

(Black Ink Layer 8)

In those cases in which a black ink layer 8 is used as the light shielding layer 2, a black ink containing carbon black as the pigment can be used. The thickness of the black ink layer 8 is preferably from 0.5 to 5 μm. The black ink layer 8 may be formed as a single layer, but from the viewpoint of preventing pinholes, is preferably formed by laminating 2 to 4 layers.

Inks containing a resin component with a hydroxyl value of 1 to 10 and an isocyanate based cross linking agent are preferred, as they generate good adhesion between the white resin film 5 and the ink, and also between the ink and the adhesive layer 4. Inks in which the resin component is a mixture of a urethane resin and a vinyl chloride-vinyl acetate-vinyl alcohol terpolymer are particularly preferred.

In cases in which the aforementioned white ink and the black ink are coated in layers, using inks with the same type of resin component is preferred in terms of generating good adhesion between the white ink and the black ink. The term “the same type” refers to, for example, using a polyester based resin with a polyester based resin, a vinyl chloride-vinyl acetate based resin with a vinyl chloride-vinyl acetate based resin, an acrylic resin with an acrylic resin, a nitrocellulose based resin with a nitrocellulose based resin, or a polyurethane based resin with a polyurethane based resin.

(Printing Method)

The inks can be printed using conventional printing methods. Examples of suitable printing methods include relief printing, flexographic printing, dry offset printing, gravure printing, gravure offset printing, offset printing and screen printing. Of these, gravure printing is ideal when multiple coats are to be printed.

The surface of the film to be printed should preferably be subjected to a conventional treatment used to improve adhesion. Of such treatments, corona treatment, plasma treatment or primer treatment is preferred.

(Thin Metal Layer 7)

A thin metal layer 7 can be used as the light shielding layer 2. There are no particular restrictions on the thin metal layer 7, although vapor deposition metal layers or ink layers containing metals are preferred. There are no particular restrictions on the type of metal used, although aluminum or silver is preferred. Furthermore, in terms of improving the adhesion between the white resin film 5 and a vapor deposition metal layer, a resin layer is preferably provided on the metal layer. Cellulose-polyurethane based resins, polyester based resins or polyester-melamine based resins are particularly preferred. In order to impart better heat resistance and safety to a vapor deposition metal layer, any of a variety of protective layers may also be provided on top of the vapor deposition metal layer.

<The Adhesive Layer 4>

(Optical Characteristics of the Adhesive Layer 4)

The adhesive layer 4 provided on the side of the light reflective layer 1 used in an adhesive tape of the present invention preferably has a light transmittance of at least 80%, with values of 85% or greater even more preferred.

The light transmittance is measured by providing a 75 μm adhesive layer 4 on a polyester film (Emblet S-25 μm, manufactured by Unitika Ltd.), and then measuring the light transmittance with a direct reading haze meter manufactured by Toyo Seiki Seisaku-Sho, Ltd.

(Yellowing Resistance of the Adhesive Layer 4)

After standing for 14 days at 100° C., the adhesive layer 4 provided on the side of the light reflective layer 1 used in an adhesive tape of the present invention, preferably displays a b* value within the L*a*b* color system (the color system specified in JIS Z 8729, wherein L* represents brightness, and a* and b* represent chromaticity) of no more than 6, with values of 4 or less being even more desirable. If the b* value exceeds 6, the yellowing of the tape increases.

(Composition of the Adhesive Layer 4)

The adhesive used in an adhesive tape of the present invention can utilize conventional acrylic, rubber, or silicon based adhesive resins. Of these, acrylic based copolymers containing a repeating unit derived from an acrylate ester comprising an alkyl group of 2 to 14 carbon atoms are preferred in terms of light resistance and heat resistance. Specific examples include acrylic based copolymers containing a repeating unit derived from n-butyl acrylate, isooctyl acrylate, 2-ethylhexyl acrylate, isononyl acrylate or ethyl acrylate.

The adhesive should also preferably comprise from 0.01 to 15% by weight of a repeating unit derived from an acrylate ester or another vinyl based monomer with a polar group such as a hydroxyl group, a carboxyl group or an amino group on a side chain.

Acrylic based copolymers can be produced by copolymerization using solution polymerization methods, bulk polymerization methods, suspension polymerization methods, emulsion polymerization methods, ultraviolet irradiation methods or electron beam irradiation methods.

The average molecular weight of the acrylic based copolymer is preferably within a range from 400,000 to 1,400,000, and even more preferably from 600,000 to 1,200,000.

A cross linking agent is also preferably added to improve the cohesion of the adhesive. Examples of suitable cross linking agents include isocyanate based cross linking agents, epoxy based cross linking agents and chelate based cross linking agents.

Particularly in those cases in which the adhesive layer 4 is provided on the ink coated surface of a white resin film that has been coated with an ink that contains a resin component with a hydroxyl value of 1 to 10 and an isocyanate based cross linking agent, the aforementioned cross linking agent should preferably utilize either an isocyanate based cross linking agent or an epoxy based cross linking agent.

The quantity of the cross linking agent is preferably adjusted so that the gel fraction of the adhesive layer is within a range from 25 to 80%. Gel fractions from 30 to 70% are even more preferred, and gel fractions from 35 to 60% are the most desirable. If the gel fraction is less than 25% then adhesive transfer during reworking becomes increasingly likely. In contrast if the gel fraction exceeds 80%, the adhesiveness of the layer deteriorates. The gel fraction is measured by immersing the cured adhesive layer 4 in toluene for a period of 24 hours, and then measuring the dried weight of the remaining insoluble fraction, and converting this fraction to a percentage relative to the initial weight.

Adhesion imparting resins may also be added to further improve the adhesive strength of the adhesive layer 4. Examples of adhesion imparting resins that can be added to the adhesive layer 4 of an adhesive tape of the present invention include rosin based resins such as rosin or esterified rosin products; terpene based resins such as diterpene polymers or copolymers of α-pinene and phenol; petroleum based resins such as aliphatic based resins (C5) or aromatic based resins (C9); as well as other resins such as styrene based resins, phenol based resins or xylene resins.

In order to ensure that the b* value of the adhesive layer following standing for 14 days at 100° C. is no more than 6, a hydrogenated rosin, an esterification product of a disproportionated rosin, or an aliphatic or aromatic petroleum resin, with a low quantity of unsaturated double bonds, is preferably added to the adhesive layer.

Combinations of a higher disproportionated rosin ester, a polymerized rosin ester, and a petroleum resin are preferred as they provide both good adhesiveness and good yellowing resistance.

If the adhesive resin is an acrylic based copolymer, then the quantity of adhesion imparting resin added is preferably within a range from 10 to 60 parts by weight per 100 parts by weight of the acrylic based copolymer base. If improving adhesion is the focus, then quantities from 20 to 50 parts by weight are the most preferred. If the adhesive resin is a rubber based resin, then the quantity of adhesion imparting resin added is preferably within a range from 80 to 150 parts by weight per 100 parts by weight of the rubber based resin. Adhesion imparting agents are not normally added to silicon based adhesives.

An adhesive layer 4 provided on the side of the light shielding layer 2 in an adhesive tape of the present invention may contain an added black colorant such as carbon black.

Other conventional additives such as plasticizers, softening agents, fillers, pigments and flame retardants can also be added to an adhesive of the present invention.

If the adhesive tape of the present invention is a double sided adhesive tape, the adhesive on the side of the light reflective layer 1 may differ from that on the side of the light shielding layer 2. In cases in which the substrate glass of the LCD panel 17 is secured to the backlight case 16, the adhesive layer 4 on the side of the light shielding layer 2, which bonds the LCD panel 17, is preferably an adhesive layer with good releasability characteristics, and moreover the adhesive strength of the adhesive layer 4 provided on the side of the light reflective layer 1 is preferably greater than the adhesive strength displayed by the adhesive layer 4 provided on the side of the light shielding layer 2. Provided such a situation is achieved, the adhesive tape of the present invention will remain bonded to the backlight case 16, even if the LCD panel 17 needs to be removed from the backlight case 16 to realign the position of the LCD panel. This enables the LCD panel 17 to be removed alone from the backlight case 16, and ensures an adhesive tape with excellent reworkability.

An ideal value for the ratio between the adhesive strength of the adhesive layer 4 provided on the side of the light reflective layer 1 relative to the backlight case 16, and the adhesive strength of the adhesive layer 4 provided on the side of the light shielding layer 2 relative to the LCD panel 17 is typically within a range from 10:1 to 10:9, and preferably from 10:2 to 10:8, and most preferably from 10:3 to 10:7.

The adhesive strength of the adhesive layer 4 provided on the side of the light reflective layer 1, relative to the backlight case 16, is preferably no more than 10.00 N/10 mm, and even more preferably within a range from 3.00 to 9.00 N/10 mm, and most preferably from 4.00 to 8.00 N/10 mm.

An adhesive layer 4 can be formed on a substrate film using the types of methods conventionally used for applying an adhesive sheet. A composition of the adhesive layer 4 can be applied directly to the film surface and then dried, or alternatively, the composition may be applied to a separator, dried, and then stuck to the substrate film.

The thickness of the adhesive layer 4 is preferably within a range from 5 to 50 μm, and even more preferably from 10 to 30 μm. If the thickness is less than 5 μm then satisfactory adhesion cannot be achieved, whereas if the thickness exceeds 50 μm, the overall thickness of the adhesive tape increases, making the tape unsuitable for use in those electronic devices in which lighter and thinner display modules have become a necessity.

In order to be suitable for these types of uses, the thickness of an adhesive tape of the present invention is preferably within a range from 20 to 100 μm, and even more preferably from 30 to 75 μm, and most preferably from 40 to 65 μm.

### EXAMPLES

As follows is a more detailed description based on a series of examples, although the present invention is in no way restricted to the examples presented below. In the following description, the units “parts” refer to “parts by weight”.

(Film Preparation)

A polyethylene terephthalate copolymer containing 18% by weight of titanium dioxide with an average particle size of 0.25 μm (wherein the temperature at which the loss tangent displays a maximum: 90° C.) was dried under vacuum at 180° C. for 4 hours and was then subjected to molten extrusion through an extruder at 290° C. The resulting sheet was cast on a mirror surface cooling drum with a surface temperature of 20° C., forming an unstretched sheet. This sheet was then preheated using a set of rollers heated to 90° C., and stretched 3.5 fold in the longitudinal direction, in a continuous manner and at a temperature of 95° C. Subsequently, the edges of the sheet were clamped with a clip, the sheet was fed into a tenter that had been heated to 105° C. and preheated, and in an atmosphere of 110° C., the sheet was then stretched 4.2 fold in the transverse direction, in a continuous manner. The sheet was then subjected to heat treatment for 8 seconds in an atmosphere of 225° C., yielding a white resin film with an overall thickness of 13 μm. The thus obtained white resin film was cut into a square sample of dimensions 500 mm×500 mm, and was then subjected to a long heat treatment of 48 hours at 70° C. with no load applied, yielding a film A.

With the exception of altering the overall thickness from 13 μm to 20 μm, a film B was produced in the same manner as the film A.

With the exception of replacing the polyethylene terephthalate copolymer containing 18% by weight of titanium dioxide with an average particle size of 0.25 μm (wherein the temperature at which the loss tangent displays a maximum: 90° C.) with a polyethylene terephthalate copolymer containing 25% by weight of titanium dioxide with an average particle size of 0.25 μm, a film C was produced in the same manner as the film B.

Raw materials of the compositions described below were supplied to a composite film formation apparatus comprising two types of extruder, extruder A and extruder B.

Extruder A: 90 parts by weight of PET chips (temperature at which the loss tangent displays a maximum: 115° C.) that had been dried under vacuum at 180° C. for 4 hours, 10 parts by weight of polymethylpentene, and 1 part by weight of polyethylene glycol with a molecular weight of 4000.

Extruder B: 100 parts by weight of pet chips containing 15% by weight of calcium carbonate with an average particle size of 1 μm (wherein the temperature at which the loss tangent displays a maximum: 115° C.), which had been dried under vacuum at 180° C. for 4 hours, and 3 parts by weight of PET master chips containing 1% by weight of an optical whitening agent (OB-1 manufactured by Eastman Chemical Company) (wherein the temperature at which the loss tangent displays a maximum: 115° C.), which had also been dried under vacuum at 180° C. for 4 hours.

The respective raw materials were subjected to molten extrusion at 290° C. through the extruders A and B, and then combined and passed through a T die to form a sheet in which the molten raw material from the extruder A formed the inner layer and the molten raw material from the extruder B formed the two surface layers. The relative thickness proportions through the composite sheet were B/A/B=5/90/5. This sheet was cast on a mirror surface cooling drum with a surface temperature of 20° C., forming an unstretched sheet. This sheet was then preheated using a set of rollers heated to 90° C., and stretched 3.5 fold in the longitudinal direction, in a continuous manner and at a temperature of 95° C. Subsequently, the edges of the sheet were clamped with a clip, the sheet was fed into a tenter that had been heated to 105° C. and preheated, and in an atmosphere of 110° C., the sheet was then stretched 4.2 fold in the transverse direction, in a continuous manner. The sheet was then subjected to heat treatment for 8 seconds in an atmosphere of 225° C., yielding a white colored film with an overall thickness of 188 μm. The thus obtained white colored film was cut into a square sample of dimensions 500 mm×500 mm, and was then subjected to a long heat treatment of 48 hours at 70° C. with no load applied, yielding a film D.

With the exception of altering the overall thickness from 188 μm to 13 μm, an attempt was made to produce a film E in the same manner as the film D, but film formation was impossible.

With the exception of using a polyethylene terephthalate containing 9% by weight of titanium dioxide with an average particle size of 0.25 μm (wherein the temperature at which the loss tangent displays a maximum: 95° C.), a film F was produced in the same manner as the film A.

With the exception of using a polyethylene terephthalate containing 25% by weight of titanium dioxide with an average particle size of 0.25 μm (wherein the temperature at which the loss tangent displays a maximum: 115° C.), a film G was produced in the same manner as the film A. The film formability of the thus obtained film G was poor.

(Black Ink Preparation)

A black ink A was prepared by adding 4 parts of CVL Hardener No. 10 (manufactured by Dainippon Ink and Chemicals, Inc.) and 35 parts of Daireducer V No. 20 (manufactured by Dainippon Ink and Chemicals, Inc.) to 100 parts of a Japanese ink (Panacea CVL-SPR805 ink, a vinyl chloride-vinyl acetate based ink manufactured by Dainippon Ink and Chemicals, Inc.).

Another black ink B was prepared by adding 35 parts of Daireducer V No. 20 (manufactured by Dainippon Ink and Chemicals, Inc.) to 100 parts of a Japanese ink (Universal 21, a nitrocellulose based ink manufactured by Dainippon Ink and Chemicals, Inc.).

(White Ink Preparation)

A white ink W was prepared by adding 2 parts of CVL Hardener No. 10 (manufactured by Dainippon Ink and Chemicals, Inc.) and 35 parts of Daireducer V No. 20 (manufactured by Dainippon Ink and Chemicals, Inc.) to 100 parts of a white ink (Panacea CVL-SP709 white, a vinyl chloride-vinyl acetate based ink manufactured by Dainippon Ink and Chemicals, Inc.).

(Substrate Preparation)

A sample of the film A was subjected to corona treatment to generate a wet tension of 50 dyne/cm, and two coats of the white ink W were then applied to the corona treated surface using gravure coating to generate a film with a dried thickness of 2 μm. Two coats of the black ink A were then applied on top of the white ink using gravure coating to generate an additional film with a dried thickness of 2 μm.

The composition was then cured for 2 days at 40° C., yielding an ink coated film (a).

With the exceptions of using the film B instead of the film A, and using the black ink B instead of the black ink A, an ink coated film (b) was prepared in the same manner as the ink coated film (a).

With the exceptions of using the film C instead of the film A, and applying the black ink without applying the white ink W, an ink coated film (c) was prepared in the same manner as the ink coated film (a).

With the exception of using the film D instead of the film C, an ink coated film (d) was prepared in the same manner as the ink coated film (c).

With the exception of using the film F instead of the film C, an ink coated film (f) was prepared in the same manner as the ink coated film (c).

With the exception of using the film G instead of the film C, an ink coated film (g) was prepared in the same manner as the ink coated film (c).

A stirred mixture comprising a 100:3 ratio of MET No. 17FT (an aluminum vapor deposition anchoring material manufactured by Dainippon Ink and Chemicals, Inc.) and CVL Hardener No. 10 respectively was gravure coated onto a sample of the film A in sufficient quantity to generate a film with a dried weight of 1 g/m². A layer of aluminum of thickness 45 nm was then formed by vapor deposition in an atmosphere at 10⁻² Pa, and the black ink A was then applied to the surface of the aluminum vapor deposition layer using gravure coating to generate a film with a dried thickness of 2 μm, thereby completing an ink coated film (h).

(Preparation of an Acrylic based Copolymer 1)

92.8 parts of n-butyl acrylate, 5 parts of vinyl acetate, 2 parts of acrylic acid, 0.2 parts of β-hydroxyethyl acrylate, and 0.2 parts of 2,2′-azobisisobutyronitrile as a polymerization initiator were dissolved in 100 parts of ethyl acetate in a reaction vessel equipped with a condenser, a stirrer, a thermometer, and a dropping funnel. The air in the reaction vessel was replaced with nitrogen, and polymerization was conducted for 8 hours at 80° C., yielding an acrylic based copolymer 1 with a weight average molecular weight of 800,000.

(Preparation of an Acrylic based Copolymer 2)

99 parts of n-butyl acrylate, 1 part of acrylic acid, and 0.2 parts of 2,2′-azobisisobutyronitrile as a polymerization initiator were dissolved in 100 parts of ethyl acetate in a reaction vessel equipped with a condenser, a stirrer, a thermometer, and a dropping funnel. The air in the reaction vessel was replaced with nitrogen, and polymerization was conducted for 8 hours at 80° C., yielding an acrylic based copolymer 2 with a weight average molecular weight of 700,000.

(Preparation of an Acrylic based Adhesive Composition)

100 parts of the above acrylic based copolymer 1, 20 parts of SUPER ESTER A100 (manufactured by Arakawa Chemical Industries, Ltd.), and 20 parts of FTR6100 (manufactured by Mitsui Chemicals, Inc.) were diluted with toluene, yielding an acrylic based adhesive composition 1 with a solid fraction of 40%.

The acrylic based copolymer 2 was diluted with toluene, yielding an acrylic based adhesive composition 2 with a solid fraction of 30%.

### Example 1

(Preparation of an Adhesive Tape)

1.5 parts of Coronate L-45 (an isocyanate based cross linking agent manufactured by Nippon Polyurethane Industry Co., Ltd.) was added to the acrylic based adhesive composition 1, and following careful stirring, the composition was applied to the surface of a polyester film of thickness 75 μm that had undergone surface lubrication treatment, in sufficient quantity to generate a dried film of thickness 18 μm, and was subsequently dried for 2 minutes at 100° C., yielding an adhesive layer. This adhesive layer was transferred to both sides of the ink coated film (a), and the composition was then laminated together using heated rollers at 80° C. and an applied pressure of 4 kgf/cm. The composition was then left to cure for 2 days at 40° C., yielding a double sided adhesive tape.

### Example 2

With the exception of using the ink coated film (b) instead of the ink coated film (a), a double sided adhesive tape was produced in the same manner as Example 1.

### Example 3

With the exception of using the ink coated film (c) instead of the ink coated film (a), a double sided adhesive tape was produced in the same manner as Example 1.

### Example 4

With the exception of using the ink coated film (h) instead of the ink coated film (a), a double sided adhesive tape was produced in the same manner as Example 1.

### Example 5

1.5 parts of Coronate L-45 (an isocyanate based cross linking agent manufactured by Nippon Polyurethane Industry Co., Ltd.) was added to the acrylic based adhesive composition 1, and following careful stirring, the composition was applied to the surface of a polyester film of thickness 75 μm that had undergone surface lubrication treatment, in sufficient quantity to generate a dried film of thickness 18 μm, and was subsequently dried for 2 minutes at 100° C., yielding an adhesive layer. This adhesive layer was transferred to the white surface of the ink coated film (a). Next, 2.5 parts of Coronate L-45 (manufactured by Nippon Polyurethane Industry Co., Ltd.) was added to the acrylic based adhesive composition 2, and following careful stirring, this composition was applied to the surface of a polyester film of thickness 75 μm that had undergone surface lubrication treatment, in sufficient quantity to generate a dried film of thickness 18 μm, and was subsequently dried for 2 minutes at 100° C., yielding an adhesive layer. This adhesive layer was transferred to the black surface of the aforementioned ink coated film, and the composition was then laminated together using heated rollers at 80° C. and an applied pressure of 4 kgf/cm. The entire composition was then left to cure for 2 days at 40° C., yielding a double sided adhesive tape.

### Example 6

With the exception of altering the dried thickness of the adhesive layer transferred to the black surface to 8 μm, a double sided adhesive tape was produced in the same manner as Example 1.

### Example 7

With the exception of using the ink coated film (f) instead of the ink coated film (a), a double sided adhesive tape was produced in the same manner as Example 1.

### Comparative Example 1

With the exception of using the ink coated film (d) instead of the ink coated film (a), a double sided adhesive tape was produced in the same manner as Example 1.

### Comparative Example 2

The film E could not be formed, and so testing was impossible.

### Comparative Example 3

With the exception of using the ink coated film (g) instead of the ink coated film (a), a double sided adhesive tape was produced in the same manner as Example 1.

The physical properties of each of the prepared films A to D and the films E to G were measured using the methods outlined below. The results of the measurements are shown in Table 1 through Table 3.

(Loss Tangent, Storage Elastic Modulus)

The loss tangent and the storage elastic modulus were measured by sandwiching a test piece of the film of width 6 mm×benchmark interval length 21 mm in a viscoelasticity measuring device (RSA II, manufactured by Rheometric Scientific Ltd.), applying a distortion of frequency 0.1 Hz to the test piece in the longitudinal direction (the lengthwise direction of the test piece), and then conducting measurements across a temperature range from 0 to 150° C. with a rate of temperature increase of 2° C./minute. Using the software supplied with the RSA II device, the relationships between the temperature and the loss tangent, and between the temperature and the storage viscoelasticity were plotted on a graph. The temperature between 0 and 150° C. at which the loss tangent displayed the maximum value, and the storage viscoelasticity at 23° C. were read directly from the graphs, and these values were recorded as the temperature at which the loss tangent displays a maximum, and the storage viscoelasticity at 23° C. respectively.

(Tensile Strength)

Tensile strength was determined in accordance with the tensile strength test method of JIS Z0237 (2000), using the following procedure.

(1) A test piece was prepared with a benchmark interval of 100 mm and a width of 25 mm, and using a Tensilon Universal Testing Machine (RTA100, manufactured by Orientec Co., Ltd.), and under conditions including a temperature of 23° C. and relative humidity of 50%, the test piece was pulled at a pull rate of 300 mm/min, and the maximum load P (N) prior to rupture was measured.

(2) The tensile strength T was then determined from the following formula. (In accordance with JIS Z 8401, the tensile strength T is calculated as a value with units of N/10 mm. Furthermore, T is calculated to one decimal place, with the second decimal place rounded.)

T=(10×P)÷W=(10×P)÷25

wherein,

T: Tensile strength (N/10 mm)

P: Maximum load prior to rupture (N)

W: Width of the test piece (mm)

Using the methods described below, each of the double side tapes prepared in Examples and Comparative Examples were evaluated in terms of adhesive strength, tape thickness, light reflectivity, light shielding characteristics (light transmittance), screen brightness, and reworkability. The results of these evaluations are shown in Table 1 through Table 3.

(Adhesive Strength)

Adhesive strength was determined in accordance with the 180 degrees peeling adhesive strength test method of JIS-Z0237 (2000), using the following procedure.

(1) An adhesive tape of an Example or a Comparative Example, of width 25 mm and backed with a 25 μm polyester film, was applied to an adherend, and under conditions including an atmospheric temperature of 23° C. and a relative humidity of 50%, a 2 kg roller was rolled twice over the tape to press the tape onto the adherend, before the tape was left to stand for 1 hour. Using a Tensilon Universal Testing Machine (RTA100, manufactured by Orientec Co., Ltd.) and under the same temperature and humidity conditions, the tape was pulled at a peeling rate of 300 mm/min, and the 180 degrees peeling adhesive strength S₂₅ was measured.

(2) The adhesive strength S was then determined from the following formula. (In accordance with JIS Z 8401, the adhesive strength S is calculated as a value with units of N/10 mm. Furthermore, S is calculated to two decimal places, with the third decimal place rounded.)

S=(10×S₂₅)÷W=(10×S₂₅)÷25

wherein,

S: Adhesive strength (N/10 mm)

S₂₅: Adhesive strength when a tape of width 25 mm is peeled (N)

W: Width of the test piece (mm)

When measuring the adhesive strength on the side of the light shielding layer 2, an LCD panel (an iodine based polarizing film: high-luminance SR grade, manufactured by Sumitomo Chemical Co., Ltd.) was used as the adherend, whereas when measuring the adhesive strength on the side of the light reflective layer 1, a backlight case (PC: polycarbonate) was used as the adherend.

(Tape Thickness)

The thickness of the double side tapes was measured with a thickness meter. Thickness readings of no more than 75 μm were considered acceptable.

(Light Reflectivity)

The reflectance from the side of the light reflective layer 1 of an adhesive tape of an Example or a Comparative Example was measured at 10 nm intervals across the wavelength range from 400 to 700 nm, using a spectrophotometric type calorimeter SE-2000 (manufactured by Nippon Denshoku Industries Co., Ltd.), and the average reflectance was then calculated.

(Light Shielding Characteristics (Light Transmittance))

Light transmittance was measured with a spectrophotometer V-520-SR (manufactured by Jasco Corporation), in accordance with JIS Z-8722, by measuring the spectral transmittance at 10 nm intervals across the wavelength range from 400 to 700 nm. The average of these measured values (the average light transmittance) was then calculated.

(Screen Brightness)

Using the standard liquid crystal display module (thin LCD module) provided in a P503 is (manufactured by Panasonic Mobile Communications Co., Ltd.), a glass LCD panel with a polarizing film attached thereto and a polycarbonate backlight case were bonded together using a double side tape from an Example or a Comparative Example, with the light reflective layer 1 facing the backlight case.

The brightness was then compared with a screen prepared by bonding the LCD panel and the backlight case using a light shielding double side tape #8616DJ black, manufactured by Dainippon Ink and Chemicals, Inc. (a black double side tape with no light reflective layer 1, and only a light shielding layer 2).

Θ: Improvement in brightness of at least 10%

◯: Improvement in brightness of at least 5%

x: Improvement in brightness of less than 5%

(Reworkability 1)

The LCD module used for evaluating the screen brightness was subjected to a 12 hours continuous lighting test (module temperature 70° C.), and the polycarbonate backlight case was then distorted by twisting, and the degree of adhesive transfer and ink peeling that occurred when the backlight case and the LCD panel separated was observed, N=10.

The evaluations were reported using the following scale:

Θ: All samples displayed no ink peeling or adhesive transfer.

◯: At least 90% of the samples displayed no ink peeling or adhesive transfer.

x: Ink peeling and/or adhesive transfer was observed in more than 10% of the samples.

(Reworkability 2)

Following the evaluations described above in reworkability 1, the tape remaining on the LCD panel or the polycarbonate backlight case was removed, and the tape was inspected for tearing. N=10.

The evaluations were reported using the following scale:

Θ: All samples displayed no tearing.

◯: At least 90% of the samples displayed no tearing.

x: Tearing was observed in more than 10% of the samples.

In addition, the b* value and the gel fraction of the adhesive were also measured, using the method described below. The results are recorded in Table 1 through Table 3.

(b* value (100° C.×14 days))

A sample produced by bonding a 75 μm adhesive layer to a transparent polyester film (Emblet S-25 μm, manufactured by Unitika Ltd.) was left to stand for 14 days at 100° C., and the sample was then placed on a standard barium sulfate plate and measured using a spectrophotometric type calorimeter SE-2000 (manufactured by Nippon Denshoku Industries Co., Ltd.).

(Gel Fraction)

A cured adhesive layer composition was immersed in toluene, and after standing for 24 hours, the dried weight of the remaining insoluble fraction was measured and converted to a percentage value relative to the initial weight.

TABLE 1

| | | | Example 1 | Example 2 | Example 3 |
|---|---|---|---|---|---|
| Reflective | Film type | | Film A | Film B | Film C |
| layer 1 | Temperature of loss tangent maximum [° C.] | | 90 | 90 | 80 |
| | Storage elastic modulus [Pa] | | 3.0 × 10⁹ | 3.2 10⁹ | 2.8 × 10⁹ |
| | Tensile strength [N/10 mm] | | 20.0 | 30.0 | 27.5 |
| | Film thickness [μm] | | 13 | 20 | 20 |
| | White colorant | Type | titanium | titanium | titanium |
| | within film | | dioxide | dioxide | dioxide |
| | | Average particle size [μm] | 0.25 | 0.25 | 0.25 |
| | | Colorant content [%] | 18 | 18 | 25 |
| | Incompatible resin | | — | — | — |
| | White ink | | W | W | — |
| | White colorant | Type | titanium | titanium | — |
| | within white ink | | dioxide | dioxide | — |
| | | Average particle size [μm] | 0.28 | 0.28 | — |
| | | Colorant content [%] | 61 | 61 | — |
| | Thickness of white ink layer [μm] | | 2 | 2 | — |
| Light | Type of black ink | | A | B | A |
| shielding | Thickness ofblack ink layer [μm] | | 2 | 2 | 2 |
| layer 2 | Thin metal layer | | | | |
| Adhesive | b* value (100° C. × 14 days) [−] | | 4.2 | 4.2 | 4.2 |
| layer 4 | Gel fraction [%] | White surface adhesive | 40 | 40 | 40 |
| | | Black surface adhesive | 40 | 40 | 40 |
| Results of | Adhesive strength | White surface (PC) | 6.00 | 6.00 | 6.00 |
| evaluations | [N/10 mm] | Black surface (polarizing film) | 5.00 | 5.00 | 5.00 |

| | | | |
|---|---|---|---|
| Tape thickness [μm] | 53 | 60 | 58 |
| | acceptable | acceptable | acceptable |
| Average reflectance [%] (400 to 700 nm) | 70 | 75 | 70 |
| Light transmittance [%] (400 to 700 nm) | <0.1 | <0.1 | <0.1 |
| Screen brightness | Θ | Θ | Θ |

| | | | | |
|---|---|---|---|---|
| Reworkability | Reworkability 1 | Θ | ◯ | Θ |
| | Reworkability 2 | ◯ | Θ | ◯ |

TABLE 2

| | | | Example | Example | Example | Example |
|---|---|---|---|---|---|---|
| | | | 4 | 5 | 6 | 7 |
| Reflective | Film type | | Film A | Film A | Film A | Film F |
| layer 1 | Temperature of loss tangent maximum [° C.] | | 90 | 90 | 90 | 95 |
| | Storage elastic modulus [Pa] | | 3.0 × 10⁹ | 3.0 × 10⁹ | 3.0 × 10⁹ | 3.0 × 10⁹ |
| | Tensile strength [N/10 mm] | | 20.0 | 20.0 | 20.0 | 22.5 |
| | Film thickness [μm] | | 13 | 13 | 13 | 13 |
| | White colorant | Type | titanium | titanium | titanium | titanium |
| | within film | | dioxide | dioxide | dioxide | dioxide |
| | | Average particle size [μm] | 0.25 | 0.25 | 0.25 | 0.25 |
| | | Colorant content [%] | 18 | 18 | 18 | 9 |
| | Incompatible resin | | — | — | — | — |
| | White ink | | — | W | W | — |
| | White colorant | Type | — | titanium | titanium | — |
| | within white ink | | | dioxide | dioxide | |
| | | Average particle size [μm] | — | 0.28 | 0.28 | — |
| | | Colorant content [%] | — | 61 | 61 | — |
| | Thickness of white ink layer [μm] | | — | 2 | 2 | — |
| Light | Type of black ink | | A | A | A | A |
| shielding | Thickness of black ink layer [μm] | | 2 | 2 | 2 | 2 |
| layer 2 | Thin metal layer | | yes | — | — | — |
| Adhesive | b* value (100° C. × 14 days) [−] | | 4.2 | 4.2 | 4.2 | 4.2 |
| layer 4 | Gel fraction | White surface adhesive | 40 | 40 | 40 | 40 |
| | [%] | Black surface adhesive | 40 | 55 | 40 | 40 |
| Results of | Adhesive | White surface (PC) | 6.00 | 6.00 | 6.00 | 6.00 |
| evaluation | strength | Black surface (polarizing film) | 5.00 | 3.00 | 2.50 | 5.00 |
| | [N/10 mm] | | | | | |
| | Tape thickness [μm] | | 52 | 53 | 43 | 53 |
| | | | acceptable | acceptable | acceptable | acceptable |
| | Average reflectance [%] (400 to 700 nm) | | 76 | 70 | 70 | 55 |
| | Light transmittance [%] (400 to 700 nm) | | <0.1 | <0.1 | <0.1 | <0.1 |
| | Screen brightness | | Θ | Θ | Θ | ∘ |
| | Reworkability | Reworkability 1 | Θ | Θ | Θ | Θ |
| | | Reworkability 2 | ∘ | ∘ | ∘ | ∘ |

TABLE 3

| | | | Comparative | Comparative | Comparative |
|---|---|---|---|---|---|
| | | | example 1 | example 2 | example 3 |
| Reflective | Film type | | Film D | Film E | Film G |
| layer 1 | | | | (film not formed) | |
| | Temperature of loss tangent maximum [° C.] | | 115 | — | 115 |
| | Storage elastic modulus [Pa] | | — | — | 4.2 × 10⁹ |
| | Tensile strength [N/10 mm] | | 45.0 | — | 9.0 |
| | Film thickness [μm] | | 188 | — | 13 |
| | White colorant | Type | calcium | — | titanium |
| | within film | | carbonate | | dioxide |
| | | Average particle size [μm] | 1 | — | 0.25 |
| | | Colorant content [%] | 1.5 | — | 25 |
| | Incompatible resin | Type | polymethyl | — | — |
| | | | pentene | | |
| | | Content [%] | 9 | — | — |
| | White ink | | — | — | — |
| | White colorant | Type | — | — | — |
| | within white ink | Average particle size [μm] | — | — | — |
| | | Colorant content [%] | — | — | — |
| | Thickness of white ink layer [μm] | | — | — | — |
| Light | Type of black ink | | A | — | A |
| shielding | Thickness ofblack ink layer [μm] | | 2 | — | 2 |
| layer 2 | Thin metal layer | | — | — | — |
| Adhesive | b* value (100° C. × 14 days) [−] | | 4.2 | — | 4.2 |
| layer 4 | Gel fraction [%] | White surface adhesive | 40 | — | 40 |
| | | Black surface adhesive | 40 | — | 40 |
| Results of | Adhesive strength | White surface (PC) | 5.50 | — | 6.00 |
| evaluation | [N/10 mm] | Black surface (polarizing film) | 4.50 | — | 5.00 |
| | Tape thickness [μm] | | 226 | — | 53 |
| | | | unacceptable | | acceptable |
| | Average reflectance [%] (400 to 700 nm) | | 90 | — | 67 |
| | Light transmittance [%] (400 to 700 nm) | | <0.1 | — | <0.1 |
| | Screen brightness | | — | — | ∘ |
| | Reworkability | Reworkability 1 | — | — | ∘ |
| | | Reworkability 2 | — | — | x |

As is evident from the results shown in Table 1 and Table 2, all of the adhesive tapes of Examples displayed excellent reworkability. Moreover, the adhesive tapes displayed good light reflectivity and light shielding characteristics, and the screen brightness of LCD panels secured using the adhesive tapes from Examples was also good. In addition, the brightness was uniform across the liquid crystal screens, and the appearance was good even at the screen extremities. Furthermore, because the gel fraction of the adhesive layer 4 falls within a specified range, and the film ink is of a specific composition, when the LCD panel was removed from the backlight case, almost no ink peeling occurred. In Example 5 and Example 6, the adhesive strength displayed by the adhesive layer on the side of the light reflective layer 1 relative to the backlight case of the LCD module is larger than the adhesive strength displayed by the adhesive layer on the side of the light shielding layer 2 relative to the LCD panel, and consequently when the LCD panel was removed from the backlight case during the reworkability 1 test, the adhesive tape remained bonded to the backlight case in all of the samples (N=10) for example 5 and example 6. Hence, the LCD panel could be effectively removed from the backlight case, indicating a superior level of reworkability for the adhesive tape. In the other examples, and in Comparative Examples, the adhesive tape remained bonded to the backlight case in only 5 or 6 of the 10 evaluation samples. Example 4 is an adhesive tape in which a thin metal layer was provided as the light shielding layer 2, and consequently the light shielding characteristics of this tape were extremely good.

In contrast, as is evident from the results shown in Table 3, the adhesive tape of Comparative Example 1 displayed excellent light reflectivity, adhesiveness and light shielding characteristics, but when the tape was used in the thin liquid crystal display module (the thin LCD module) used for the tests, the tape was overly thick, causing the LCD panel to protrude from the backlight case when the tape was bonded inside the LCD module, indicating that the adhesive tape is not suitable for securing an LCD panel to a backlight case in a thin LCD module. In comparative example 2, where an attempt was made to reduce the thickness of the tape substrate, film formation proved impossible. Comparative Example 3 provided an adhesive tape that displayed excellent light reflectivity, adhesiveness and light shielding characteristics, but the tape failed during reworking. Moreover, the film formability was also extremely poor for Comparative Example 3.

What is claimed is:

1. An adhesive tape
(a) which combines light reflectivity and light shielding characteristics, which is used for bonding between an LCD panel and a backlight case of an LCD module,
(b) and which comprises a backing formed by laminating a light reflective layer and a light shielding layer, and an adhesive layer provided on at least one surface of said backing,
(c) wherein said light reflective layer is formed of a white resin film with a thickness within a range from 10 to 30 μm, and a tensile strength of at least 10.0 N/10 mm.

2. An adhesive tape according to claim 1, wherein said white resin film comprises a polyester resin and fine particles of a white colorant dispersed within said resin, and is a biaxially stretched film with a maximum value for a loss tangent which occurs at a temperature within a range from 60 to 100° C.

3. An adhesive tape according to claim 1, wherein said light reflective layer is formed from said white resin film and a white ink layer provided on at least one surface of said white resin film.

4. An adhesive tape according to claim 1, wherein said light shielding layer comprises a thin metal layer.

5. An LCD module, wherein an adhesive tape according to any one of claim 1 through claim 4 is bonded between an LCD panel and a backlight case.
